(19) United States
(12) Patent Application Publication
(10) Pub. No.: US 2006/0125397 A1
(43) Pub. Date: Jun. 15, 2006

(54) Plasma display panel

(75) Inventors: Woong Kee Min, Seoul (KR); Yong Han Lee, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/302,441

(22) Filed: Dec. 14, 2005

(30) Foreign Application Priority Data
Dec. 14, 2004 (KR) 10-2004-0105779

(51) Int. Cl. H01J 17/49

(52) U.S. Cl. 313/582; 313/583; 313/584

(57) ABSTRACT

The present invention relates to a plasma display panel. In the plasma display panel according to an embodiment of the present invention, a scan electrode, a sustain electrode and a scan electrode are sequentially arranged, and the resistance of the sustain electrode is lower than the resistance of the scan electrode. An embodiment of the present invention can reduce a difference between a voltage drop of the scan electrode and a voltage drop of the sustain electrode and can also reduce brightness deviation.

This Nonprovisional application claims priority under 35 U.S.C. § 119(a) on Patent Application No. 10-2004-105779 filed in Korea on Dec. 14, 2004 the entire contents of which are hereby incorporated by reference.

### BACKGROUND OF THE INVENTION

1. Field of the Invention

The present invention relates to a plasma display panel.

2. Description of the Background Art

FIG. 1 is a perspective view showing the structure of a plasma display panel in the related art. As shown in FIG. 1, the plasma display panel in the related art comprises a front panel 100 and a rear panel 110. The front panel 100 comprises a front glass substrate 101 and the rear panel comprises a rear glass substrate 111. The front panel 100 and the rear panel 110 are parallel to each other with a predetermined distance therebetween.

Sustain electrode pairs 102, 103 for sustaining the emission of a cell through mutual discharge are formed on the front glass substrate 101. The sustain electrode pair 102, 103 comprise a scan electrode 102 and a sustain electrode 103. The scan electrode 102 comprises a transparent electrode 102a formed of a transparent ITO material and a bus electrode 102b formed of a metal material. The sustain electrode 103 comprises a transparent electrode 103a formed of a transparent ITO material and a bus electrode 103b formed of a metal material. The scan electrode 102 receives a scan signal for scanning the panel and a sustain signal for sustaining a discharge. The sustain electrode 103 mainly receives a sustain signal. An upper dielectric layer 104 is formed on the sustain electrode pairs 102, 103, and it functions to limit a discharge current and provides insulation between the scan electrode 102 and the sustain electrode 103. A protection layer 105 is formed on a top surface of the dielectric layer 104 and is formed of Magnesium Oxide (MgO) so as to facilitate a discharge condition.

Address electrodes 113 crossing the sustain electrode pairs 102, 103 are disposed on the rear glass substrate 111. A lower dielectric layer 115 is formed on the address electrodes 113 and functions to provide insulation between the address electrodes 113. Barrier ribs 112 are formed on the dielectric layer 115 and partition discharge cells. Phosphor layers 114 are coated between the barrier ribs 112 and radiate a visible ray for displaying images.

The front glass substrate 101 and the rear glass substrate 111 are coalesced by a sealing material. Inert gases, such as helium (He), neon (Ne) and xeon (Xe), are injected into the plasma display panel after an exhaust process is performed.

The electrode structure of the related art plasma display panel constructed above will be described with reference to FIG. 2.

FIG. 2 shows an electrode structure of the plasma display panel in the related art. As shown in FIG. 2, the electrode arrangement of the plasma display panel 200 has a matrix form of n×m. Address electrodes X₁ to Xₘ are arranged in a column direction and scan electrodes Y₁ to Yₙ and sustain electrodes Z₁ to Zₙ are arranged in a row direction.

An address electrode driver 220 supplies a data pulse to the address electrodes X₁ to Xₘ. A scan electrode driver 230 supplies a reset pulse, a scan pulse or a sustain pulse to the scan electrodes Y₁ to Yₙ. A sustain electrode driver 240 supplies a sustain pulse to the sustain electrodes Z₁ to Zₙ. A controller 210 controls a pulse supply time point of the address electrode driver 220, the scan electrode driver 230 or the sustain electrode driver 240.

The structure of the scan electrodes Y₁ to Yₙ or the sustain electrodes Z₁ to Zₙ to which the pulse is supplied by the scan electrode driver 230 or the sustain electrode driver 240 will be described with reference to FIGS. 3a and 3b.

FIGS. 3a and 3b show the structure of the scan electrodes and the sustain electrodes of the plasma display panel in the related art.

In the electrode structure shown in FIG. 3a, the scan electrode and the sustain electrode are formed in turn. In the electrode structure shown in FIG. 3a, one scan electrode and one sustain electrode form a sustain electrode pair. That is, as one scan electrode and one sustain electrode form a pair, a pulse is supplied to a discharge cell.

For example, each of a first scan electrode Y₁ and a first sustain electrode Z₁, a second scan electrode Y₂ and a second sustain electrode Z₂, a third scan electrode Y₃ and a third sustain electrode Z₃, a fourth scan electrode Y₄ and a fourth sustain electrode Z₄, . . . and a n^{th} scan electrode Yₙ and a n^{th} sustain electrode Zₙ forms one sustain electrode pair.

In the electrode structure shown in FIG. 3b, the scan electrode, the sustain electrode, the sustain electrode and the scan electrode-are sequentially formed. In the electrode structure shown in FIG. 3b, one scan electrode and one sustain electrode form a sustain electrode pair. That is, as one scan electrode and one sustain electrode form a pair, a pulse is applied to a discharge cell.

As shown in FIG. 3b, a second sustain electrode Z₂ and a third sustain electrode Z₃ are adjacent to each other. A fourth sustain electrode Z₄ and a fifth sustain electrode Z₅ are adjacent to each other. The sustain electrode is simply supplied with a sustain pulse. Therefore, the second sustain electrode Z₂ and the third sustain electrode Z₃ can be integrated into one sustain electrode, and the fourth sustain electrode Z₄ and the fifth sustain electrode Z₅ can be integrated into one sustain electrode. The common sustain electrode structure has an electrode structure in which two sustain electrodes are integrated into one sustain electrode.

FIG. 4 shows the structure of a common sustain electrode structure of the plasma display panel in the related art. As shown in FIG. 4, neighboring two sustain electrodes are integrated into one sustain electrode in the structure in which the electrodes are arranged in order of the scan electrode, the sustain electrode, the sustain electrode and the scan electrode in the electrode structure shown in FIG. 3b.

That is, in the electrode structure shown in FIG. 4, the scan electrode, the sustain electrode and the scan electrode are sequentially formed. In the electrode structure of FIG. 4, two scan electrodes and one sustain electrode form two sustain electrodes pairs.

For example, the second scan electrode Y₂, the third scan electrode Y₃ and the second sustain electrode Z₂ form two sustain electrodes pairs. Therefore, a pulse is supplied to a discharge cell by means of the second scan electrode Y₂ and the second sustain electrode Z₂. A pulse is applied to a discharge cell by means of the third scan electrode Y₃ and the second sustain electrode Z₂.

In the electrode structure of FIG. 4, the cross section area of the scan electrode is the same as the cross section area of the sustain electrode. Furthermore, as shown in FIG. 1, each of the scan electrode and the sustain electrode comprises a transparent electrode and a bus electrode. That is, the cross section area of the scan electrode is the same as the cross section area of the sustain electrode. The material constituting the scan electrode is the same as The material constituting the sustain electrode. Therefore, in the electrode structure shown in FIG. 4, the resistance of one scan electrode is the same as the resistance of one sustain electrode.

Furthermore, in the electrode structure shown in FIG. 4, the second sustain electrode Z₂ forms one sustain electrode pair along with the second scan electrode Y₂ and also forms one sustain electrode pair along with the third scan electrode Y₃. Therefore, an amount of current flowing through the second sustain electrode Z₂ is twice of an amount of current flowing through the second scan electrode Y₂. That is, an amount of current flowing through one sustain electrode is twice of an amount of current flowing through one scan electrode.

However, since the resistance of one sustain electrode is the same as the resistance of one scan electrode, a voltage drop occurring in one sustain electrode is twice of a voltage drop occurring in one scan electrode.

FIG. 5 is a view illustrating a current flowing through the scan electrode and the sustain electrode in the common sustain electrode structure of the plasma display panel in the related art. As shown in FIG. 5, an amount of current flowing through the end point of one sustain electrode is twice of an amount of current flowing through the end point of one scan electrode.

Therefore, a voltage drop generated by one sustain electrode is different from a voltage drop generated by one scan electrode.

FIG. 6 shows a voltage drop by the scan electrode and the sustain electrode in the common sustain electrode structure of the plasma display panel in the related art. As shown in FIG. 6, since an amount of current flowing through the scan electrode and an amount of current flowing through the sustain electrode are different from each other, a voltage drop by the scan electrode and a voltage drop by the sustain electrode are different from each other. The prior art plasma display panel has a problem in that brightness deviation occurs in a direction along which the scan electrode or the sustain electrode proceeds because a voltage drop by the scan electrode and a voltage drop by the sustain electrode are different from each other.

### SUMMARY OF THE INVENTION

Accordingly, an object of an embodiment of the present invention is to solve at least the problems and disadvantages of the background art.

It is an object of an embodiment of the present invention to provide a plasma display panel in which a difference between a voltage drop by the scan electrode and a voltage drop by the sustain electrode can be reduced.

It is another object of an embodiment of the present invention to provide a plasma display panel in which brightness deviation can be reduced.

A plasma display panel according to an aspect of the present invention comprises a first electrode having a first cross section area, a second electrode having a second cross section area larger than the first cross section area, and forming a sustain electrode pair along with the first electrode, and a third electrode having a third cross section area smaller than the second cross section area, and forming another sustain electrode pair along with the second electrode.

A plasma display panel according to another aspect of the present invention comprises a first electrode having a first resistivity, a second electrode having a second resistivity lower than the first resistivity, and forming a sustain electrode pair along with the first electrode, and a third electrode having a third resistivity higher than the second resistivity, and forming another sustain electrode pair along with the second electrode.

A plasma display panel according to still another aspect of the present invention comprises a first electrode having a first resistance, a second electrode having a second resistance lower than the first resistance, and forming a sustain electrode pair along with the first electrode, and a third electrode having a third resistance higher than the second resistance, and forming another sustain electrode pair along with the second electrode.

In a plasma display panel according to an embodiment of the present invention, resistance of a sustain electrode is set to be lower than resistance of a scan electrode. Therefore, a difference between a voltage drop in the scan electrode and a voltage drop in the sustain electrode can be reduced.

Furthermore, in a plasma display panel according to an embodiment of the present invention, resistance of a sustain electrode is set to be lower than resistance of a scan electrode. Therefore, brightness deviation can be reduced.

### BRIEF DESCRIPTION OF THE DRAWINGS

An Embodiment of the invention will be described in detail with reference to the following drawings in which like numerals refer to like elements.

FIG. 1 is a perspective view showing the structure of a plasma display panel in the related art;

FIG. 2 shows an electrode structure of the plasma display panel in the related art;

FIGS. 3a and 3b show the structure of a scan electrode and a sustain electrode of the plasma display panel in the related art;

FIG. 4 shows the structure of a common sustain electrode structure of the plasma display panel in the related art;

FIG. 5 is a view illustrating a current flowing through the scan electrode and the sustain electrode in the common sustain electrode structure of the plasma display panel in the related art;

FIG. 6 shows a voltage drop by the scan electrode and the sustain electrode in the common sustain electrode structure of the plasma display panel in the related art;

FIG. 7 shows electrodes of a plasma display panel according to a first embodiment of the present invention;

FIGS. 8-a to 8d are views illustrating a method of manufacturing a plasma display panel according to a first embodiment of the present invention;

FIG. 9 shows electrodes of a plasma display panel according to a second embodiment of the present invention;

FIGS. 10a to 10g are views illustrating a method of manufacturing a plasma display panel according to a second embodiment of the present invention;

FIG. 11 shows electrodes of a plasma display panel according to a third embodiment of the present invention;

FIGS. 12a to 12f are views illustrating a method of manufacturing a plasma display panel according to a third embodiment of the present invention;

FIG. 13 is a view illustrating a current flowing through the electrodes of the plasma display panel according to the first to third embodiments of the present invention; and

FIG. 14 shows a voltage drop by the electrodes of the plasma display panel according to the first to third embodiments of the present invention.

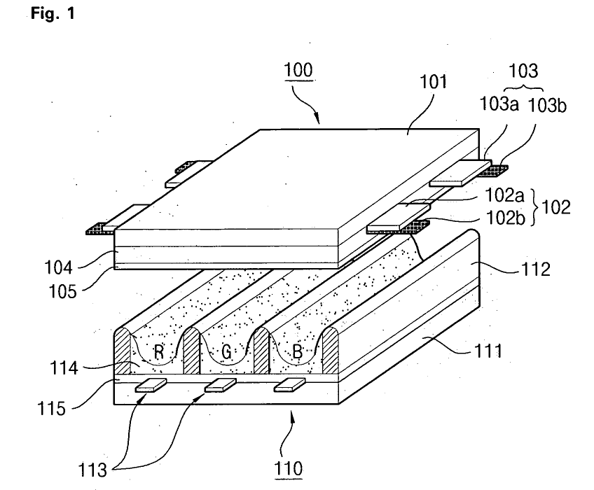

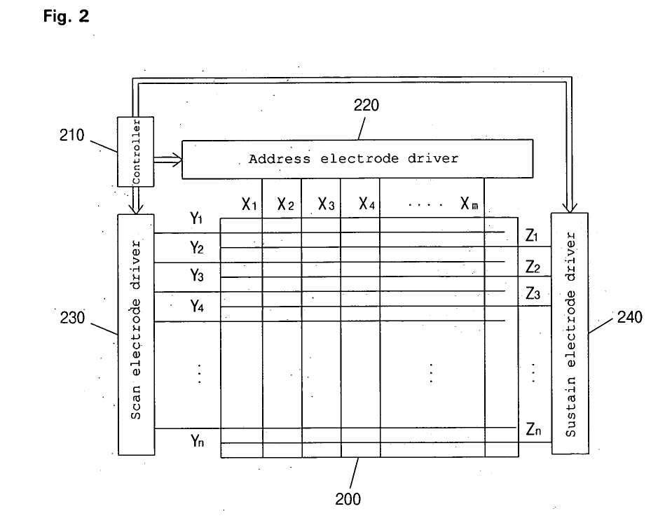

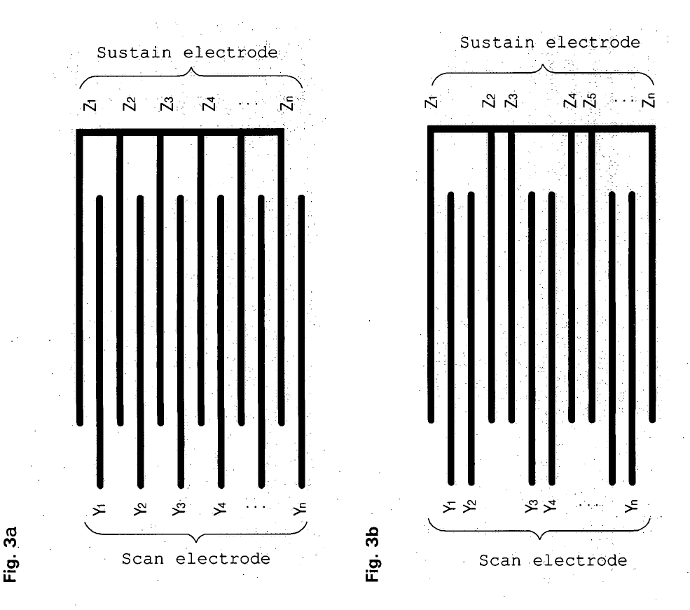

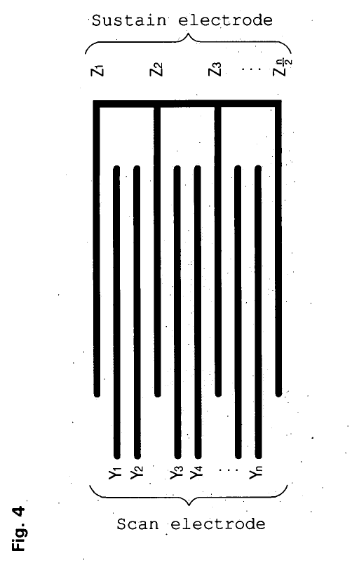

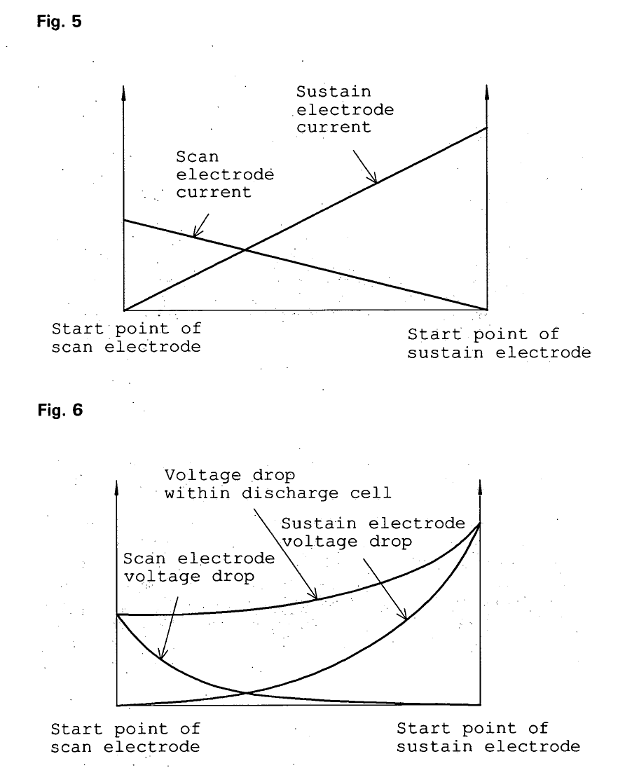

### DETAILED DESCRIPTION OF PREFERRED EMBODIMENTS

Embodiments of the present invention will be described in a more detailed manner with reference to the drawings.

A plasma display panel according to an aspect of the present invention comprises a first electrode having a first cross section area, a second electrode having a second cross section area larger than the first cross section area, and forming a sustain electrode pair along with the first electrode, and a third electrode having a third cross section area smaller than the second cross section area, and forming another sustain electrode pair along with the second electrode.

The first electrode and the third electrode may serve as a scan electrode, and the second electrode serves as a sustain electrode.

The width of the second electrode may be wider than the width of each of the first electrode and the third electrode

The thickness of the second electrode may be greater than the thickness of each of the first electrode and the third electrode.

Each of the first electrode, the second electrode and the third electrode may comprise a transparent electrode, and the width of the transparent electrode of the second electrode may be wider than the width of each of the transparent electrode of the first electrode and the transparent electrode of the third electrode.

Each of the first electrode, the second electrode and the third electrode may comprises a bus electrode, and the width of the bus electrode of the second electrode may be wider than the width of each of the bus electrode of the first electrode and the bus electrode of the third electrode.

Each of the first electrode, the second electrode and the third electrode may comprise a transparent electrode, and the thickness of the transparent electrode of the second electrode may be greater than the thickness of each of the transparent electrode of the first electrode and the transparent electrode of the third electrode.

Each of the first electrode, the second electrode and the third electrode may comprise a bus electrode, and the thickness of the bus electrode of the second electrode may be greater than the thickness of each of the bus electrodes of the first electrode and the bus electrodes of the third electrode.

The width of the second electrode may be 1.6 to 2.0 times of the width of the first electrode or the third electrode.

The thickness of the second electrode may be 1.6 to 2.0 times of the width of the first electrode or the third electrode.

A plasma display panel according to another aspect of the present invention comprises a first electrode having a first resistivity, a second electrode having a second resistivity lower than the first resistivity, and forming a sustain electrode pair along with the first electrode, and a third electrode having a third resistivity higher than the second resistivity, and forming another sustain electrode pair along with the second electrode.

The first electrode and the third electrode may serve as a scan electrode, and the second electrode may serve as a sustain electrode.

The width of the second electrode may be wider than the width of each of the first electrode and the third electrode.

The thickness of the second electrode may be greater than the thickness of each of the first electrode and the third electrode.

The first electrode and the third electrode are formed of copper, and the second electrode is formed of silver.

A plasma display panel according to still another aspect of the present invention comprises a first electrode having a first resistance, a second electrode having a second resistance lower than the first resistance, and Forming a sustain electrode pair along with the first electrode, and a third electrode having a third resistance higher than the second resistance, and forming another sustain electrode pair along with the second electrode.

The cross section area of the second electrode may be larger than the cross section area of each of the first electrode and the third electrode.

The width of the first electrode, the width of the second electrode and the width of the third electrode may be the same, and the thickness of the second electrode may be greater than the thickness of each of the first electrode and the third electrode.

The thickness of the first electrode, the thickness of the second electrode and the thickness of the third electrode may be the same, and the width of the second electrode may be wider than the width of each of the first electrode and the third electrode.

The cross section area of the first electrode, the cross section area of the second electrode and the cross section area of the third electrode may be the same, and the resistivity of the second electrode may be lower than the resistivity of each of the first electrode and the third electrode.

Detailed embodiments of the present invention will now be described with reference to the accompanying drawings.

### First Embodiment

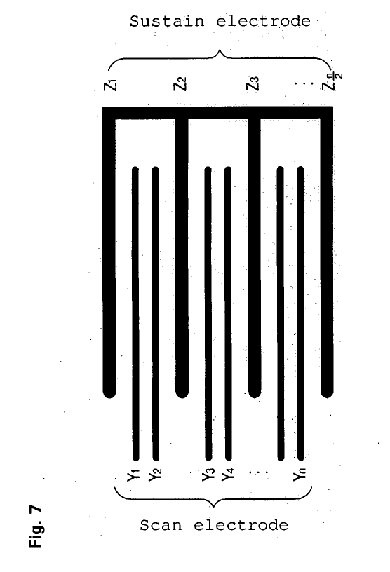

FIG. 7 shows electrodes of a plasma display panel according to a first embodiment of the present invention. As shown in FIG. 7, in the electrode structure of the plasma display panel according to a first embodiment of the present invention, a scan electrode, a sustain electrode and a scan electrode are sequentially formed.

Therefore, two scan electrodes and one sustain electrode form two sustain electrodes pairs. For example, a second scan electrode Y₂ and a second sustain electrode Z₂ form one sustain electrode pair, and a third scan electrode Y₃ and a second sustain electrode Z₂ form one sustain electrode pair. Therefore, a pulse is supplied to a discharge cell by means of the second scan electrode Y₂ and the second sustain electrode Z₂. A pulse is supplied to a discharge cell by means of the third scan electrode Y₃ and the second sustain electrode Z₂.

The sustain electrode and the scan electrode are formed of the same material, the thickness of the sustain electrode is the same as the thickness of the scan electrode, and the width of the sustain electrode is wider than the width of the scan electrode. Therefore, since the cross section area of the sustain electrode is larger than the cross section area of the scan electrode, the resistance of the sustain electrode is lower than the resistance of the scan electrode. The width of the sustain electrode is 1.6 to 2.4 times of the width of the scan electrode.

In the electrode structure of the plasma display panel according to the first embodiment of the present invention, the second sustain electrode Z₂ forms one sustain electrode pair along with the second scan electrode Y₂ and forms another sustain electrode pair along with the third scan electrode Y₃. Therefore, a current flowing through the second sustain electrode Z₂ in a sustain period is twice of a current flowing through one scan electrode. However, since the cross section area of the sustain electrode is larger than the cross section area of the scan electrode, the resistance of the sustain electrode is lower than the resistance of the scan electrode.

Therefore, in the first embodiment of the present invention, a difference between a voltage drop in the sustain electrode and a voltage drop in the scan electrode is smaller than a difference between a voltage drop in the sustain electrode and a voltage drop in the scan electrode in the related art. Therefore, in accordance with the first embodiment of the present invention, brightness deviation can be reduced.

When the width of the sustain electrode is twice of the width of the scan electrode, a difference between a voltage drop in the sustain electrode and a voltage drop in the scan electrode is further reduced in the first embodiment of the present invention.

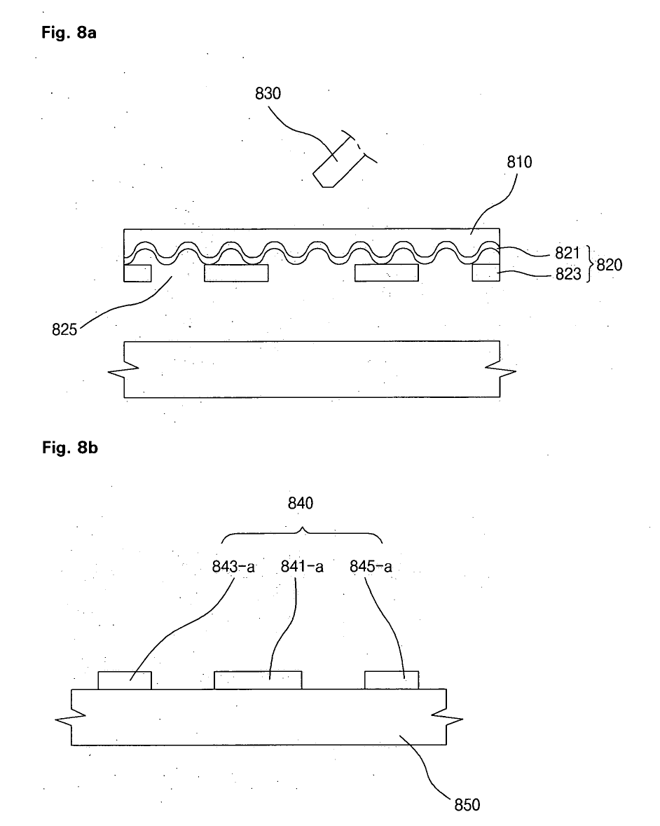

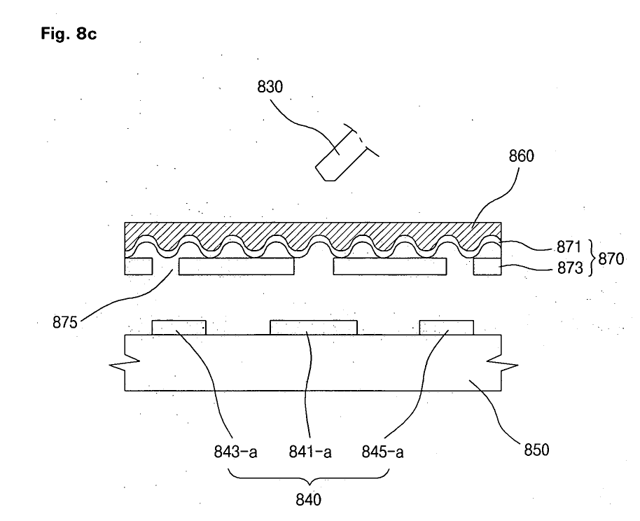

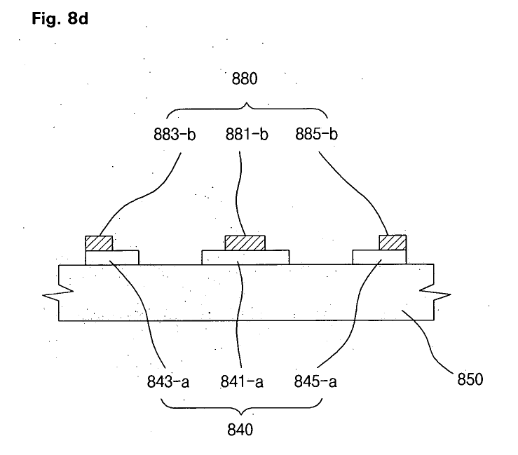

FIGS. 8a to 8d are views illustrating a method of manufacturing a plasma display panel according to a first embodiment of the present invention.

As shown in FIG. 8a, a transparent electrode paste 810 for forming a transparent electrode is coated on a screen mask 820. The transparent electrode paste 810 is pushed out downwardly using a squeeze 830. The screen mask 820 comprises a mesh net 821, which is generally formed of metal, and a pattern forming layer 823 in which the pattern of a transparent electrode is formed. In the pattern forming layer 823, the width of the transparent electrode pattern serving as the sustain electrode is wider than the width of the transparent electrode pattern serving as the scan electrode.

If the transparent electrode paste 810 is pushed out using the squeeze 830 as described above, the transparent electrode paste 810 is moved through a hole 825 depending on the pattern of the pattern forming layer 821. Therefore, transparent electrodes 840 are formed on a glass substrate 850, as shown in FIG. 8b. One transparent electrode 841-a of the transparent electrodes 840 serves as the sustain electrode, and each of two transparent electrodes 843-a, 845-a adjacent to the transparent electrode 841-a serves as the scan electrode. The width of the transparent electrode 841-a serving as the sustain electrode is wider than The width of the transparent electrode 843-a or 845-a serving as the scan electrode.

As shown in FIG. 8c, a silver paste 860 for forming a bus-electrode is coated on a mesh net 871 of a screen mask 870 and is then pushed out using the squeeze 830. The width of a bus electrode pattern for a sustain electrode of a pattern forming layer 873 is the same as or wider than the width of a bus electrode pattern for a scan electrode.

As shown in FIG. 8d, if the Ag paste 860 is pushed out by the squeeze 830, the Ag paste 860 moves through a hole 875 depending on the pattern of the pattern forming layer 873 of the screen mask 870. Therefore, bus electrodes 880 are formed on the transparent electrodes 840. One bus electrode 881-b of the bus electrodes 880 serves as the sustain electrode and each of two bus electrodes 883-b, 885-b adjacent to the bus electrode 881-b serves as the scan electrode. The width of the bus electrode 881-b serving as the sustain electrode is the same as or wider than the width of the bus electrode 883-b or 885-b serving as the scan electrode.

### Second Embodiment

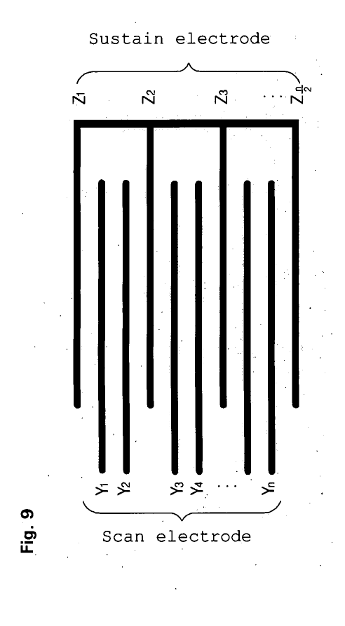

FIG. 9 shows electrodes of a plasma display panel according to a second embodiment of the present invention. In the second embodiment of the present invention, the width of the sustain electrode is the same as the width of the scan electrode and the thickness of the sustain electrode is greater than the thickness of the scan electrode.

As shown in FIG. 9, in the electrode structure of the plasma display panel according to the second embodiment of the present invention, a scan electrode, a sustain electrode and a scan electrode are sequentially formed.

Therefore, two scan electrodes and one sustain electrode form two sustain electrodes pairs. For example, a second scan electrode Y₂ and a second sustain electrode Z₂ form one sustain electrode pair, and a third scan electrode Y₃ and a second sustain electrode Z₂ form another sustain electrode pair.

The sustain electrode and the scan electrode are formed of the same material, the width of the sustain electrode is the same as the width of the scan electrode, and the thickness of the sustain electrode is greater than the thickness of the scan electrode. Therefore, since the cross section area of the sustain electrode is larger than the cross section area of the scan electrode, the resistance of the sustain electrode is lower than the resistance of the scan electrode. The thickness of the sustain electrode is 1.6 to 2.4 times less than the thickness of the scan electrode.

In the electrode structure of the plasma display panel according to the second embodiment of the present invention, the second sustain electrode Z₂ forms one sustain electrode pair along with the second scan electrode Y₂ and forms another sustain electrode pair along with the third scan electrode Y₃. Therefore, a current flowing through the second sustain electrode Z₂ in a sustain period is twice of a current flowing through one scan electrode and the resistance of the sustain electrode is lower than the resistance of the scan electrode. Therefore, the second embodiment of the present invention can reduce brightness deviation.

When the thickness of the sustain electrode is twice of the thickness of the scan electrode, a difference between a voltage drop in the sustain electrode and a voltage drop in the scan electrode is further reduced in the second embodiment of the present invention.

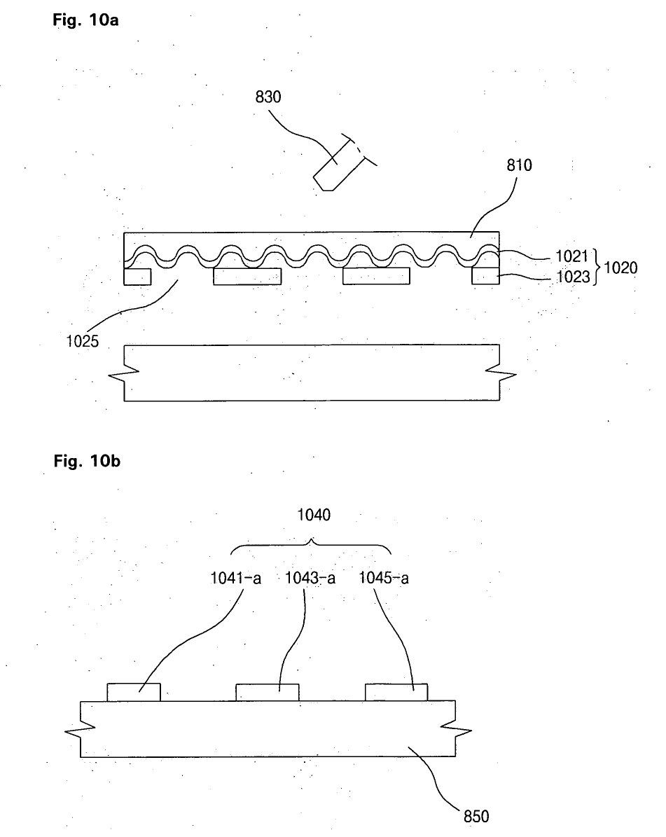

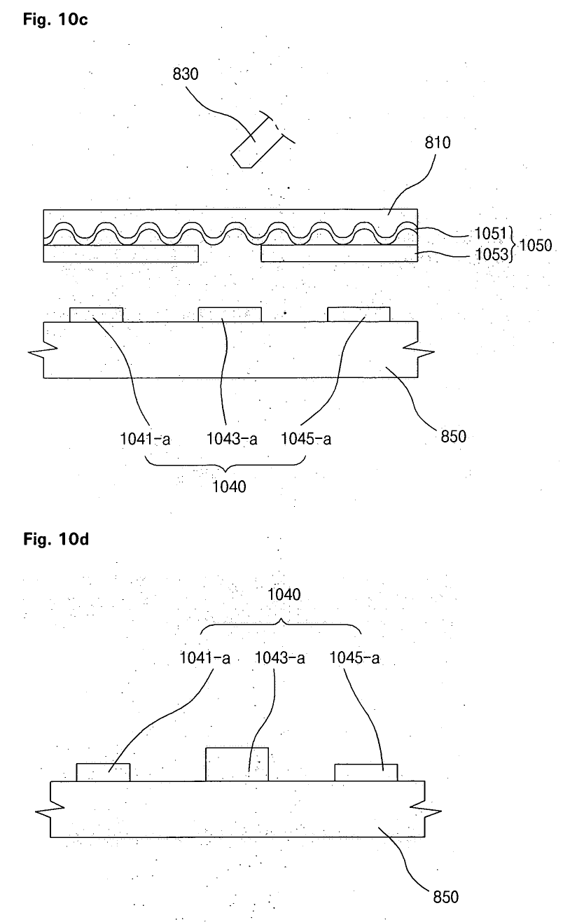

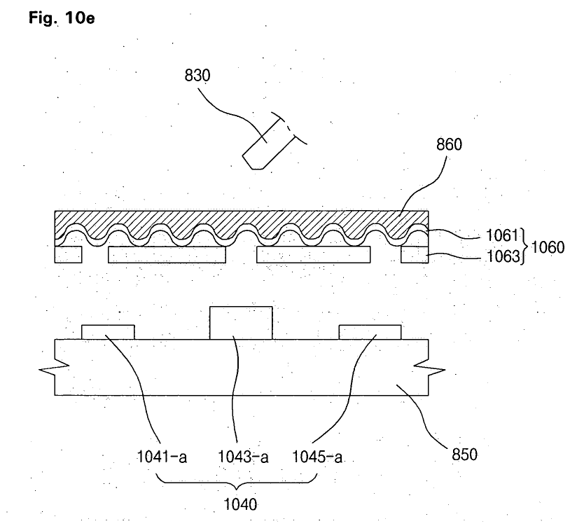

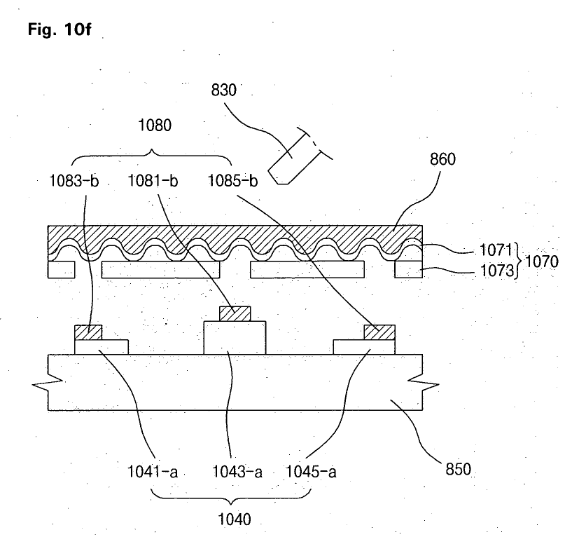

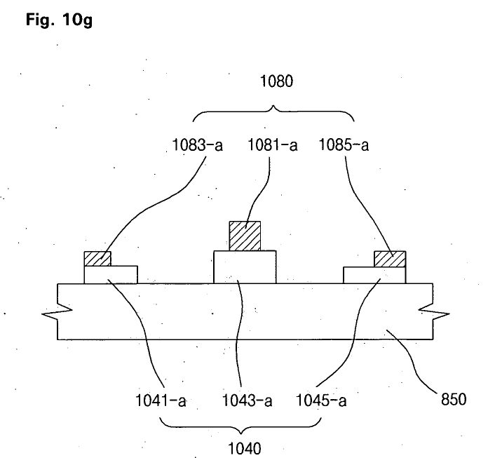

FIGS. 10a to 10g are views illustrating a method of manufacturing a plasma display panel according to a second embodiment of the present invention.

As shown in FIG. 10a, a transparent electrode paste 810 for forming a transparent electrode is coated on a screen mask 1020. The transparent electrode paste 810 is pushed out downwardly using a squeeze 830. The screen mask 1020 comprises a mesh net 1021 and a pattern forming layer 1023. In the pattern forming layer 1023, the width of a transparent electrode pattern serving as a sustain electrode is the same as the width of a transparent electrode pattern serving as a scan electrode.

If the transparent electrode paste 810 is pushed out using the squeeze 830 as described above, the transparent electrode paste 810 moves through a hole 1025 depending on the pattern of the pattern forming layer 1021. Therefore, transparent electrodes 1040 are formed on a glass substrate 850, as shown in FIG. 10b. The width of each of the transparent electrodes 1040 is the same. One transparent electrode 1041-a of the transparent electrodes 1040 serves as the sustain electrode, and each of two transparent electrodes 1043-a, 1045-a adjacent to the transparent electrode 1041-a serves as the scan electrode.

As shown in FIG. 10c, to increase the thickness of the transparent electrode 1041-a serving as the sustain electrode, the transparent electrode paste 810 is pushed out downwardly using the squeeze 830 after the transparent electrode paste 810 is coated on the screen mask 1020.

If the transparent electrode paste 810 is pushed out by the squeeze 830 as described above, the thickness of the transparent electrode 1041-a serving as the sustain electrode is greater than the thickness of each of the transparent electrodes 1043-a, 1045-a serving as the scan electrode, as shown in FIG. 10d. Therefore, the cross section area of the transparent electrode 1041-a serving as the sustain electrode is larger than the cross section area of each of the transparent electrodes 1043-a, 1045-a serving as the scan electrode.

As shown in FIG. 10e, after an Ag paste 860 for forming bus electrodes is coated on a mesh net 1061 of a screen mask 1060, the Ag paste 860 is pushed out downwardly using the squeeze 830. The width of a bus electrode pattern for the sustain electrode of a pattern forming layer 1063 is the same as the width of the bus electrode pattern for the scan electrode.

As shown in FIG. 10f, bus electrodes 1080 are formed on the transparent electrodes 1040. One bus electrode 1081-b of the bus electrodes 1080 serves as the sustain electrode and each of two bus electrodes 1083-b, 1085-b adjacent to one bus electrode 1081-b serves as the scan electrode. The width of the bus electrode 1081-b serving as the sustain electrode is the same as the width of the bus electrode 1083-b or 1085-b serving as the scan electrode. Thereafter, to increase the thickness of the bus electrode 1081-b serving as the sustain electrode, the Ag paste 860 is coated on the screen mask 1070 and is then pushed out downwardly using the squeeze 830.

As shown in FIG. 10g, the thickness of the bus electrode 1081-b serving as the sustain electrode is greater than the thickness of each of the bus electrodes 1083-b, 1085-b serving as the scan electrode. Therefore, the cross section area of the bus electrode 1081-b serving as the sustain electrode is larger than the cross section area of each of the bus electrodes 1083-b, 1085-b serving as the scan electrode.

### Third Embodiment

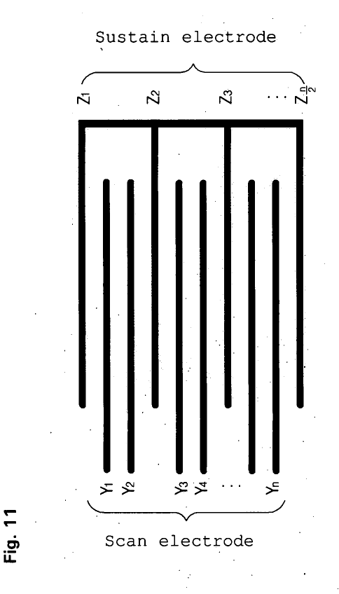

FIG. 11 shows electrodes of a plasma display panel according to a third embodiment of the present invention. In the third embodiment of the present invention, the width and thickness of a sustain electrode are the same as those of a scan electrode, and the resistivity of a material forming the sustain electrode is lower than the resistivity of a material forming the scan electrode.

As shown in FIG. 11, in the electrode structure of the plasma display panel according to the third embodiment of the present invention, a scan electrode, a sustain electrode and a scan electrode are sequentially formed.

Therefore, two scan electrodes and one sustain electrode form two sustain electrodes pairs. For example, a second scan electrode Y₂ and a second sustain electrode Z₂ form one sustain electrode pair, and a third scan electrode Y₃ and a second sustain electrode Z₂ form another sustain electrode pair.

In the electrode structure of the plasma display panel according to the third embodiment of the present invention, the second sustain electrode Z₂ forms one sustain electrode pair along with the second scan electrode Y₂ and forms another sustain electrode pair along with the third scan electrode Y₃. Therefore, a current flowing through the second sustain electrode Z₂ in a sustain period is twice of a current flowing through one scan electrode. Furthermore, since the resistivity of a material forming the sustain electrode is lower than the resistivity of a material forming the scan electrode, the resistance of the sustain electrode is lower than the resistance of the scan electrode. Therefore, the third embodiment of the present invention can reduce brightness deviation.

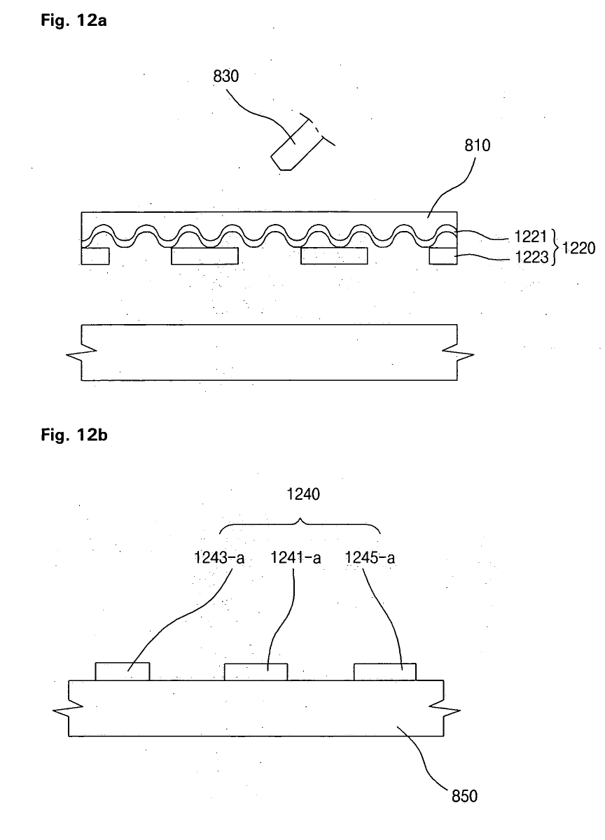

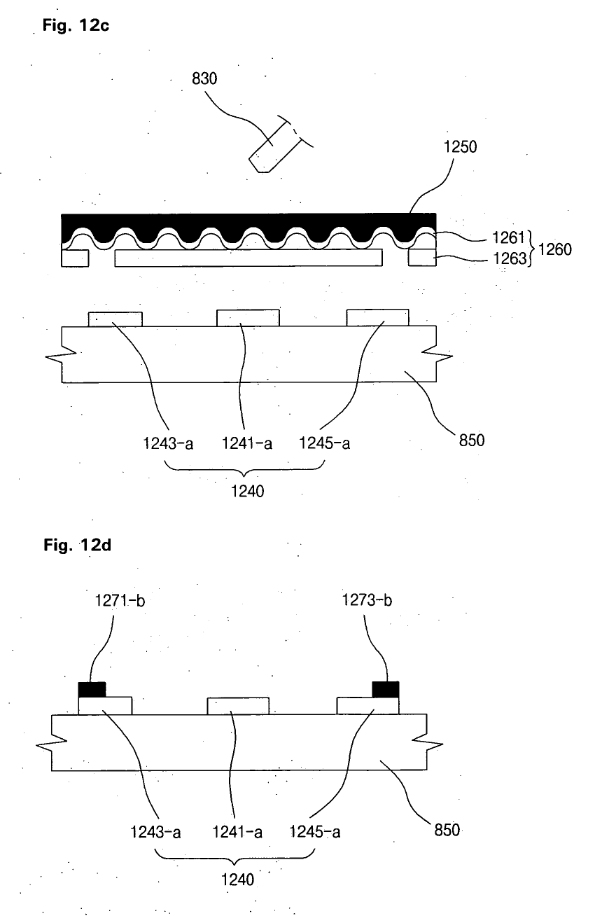

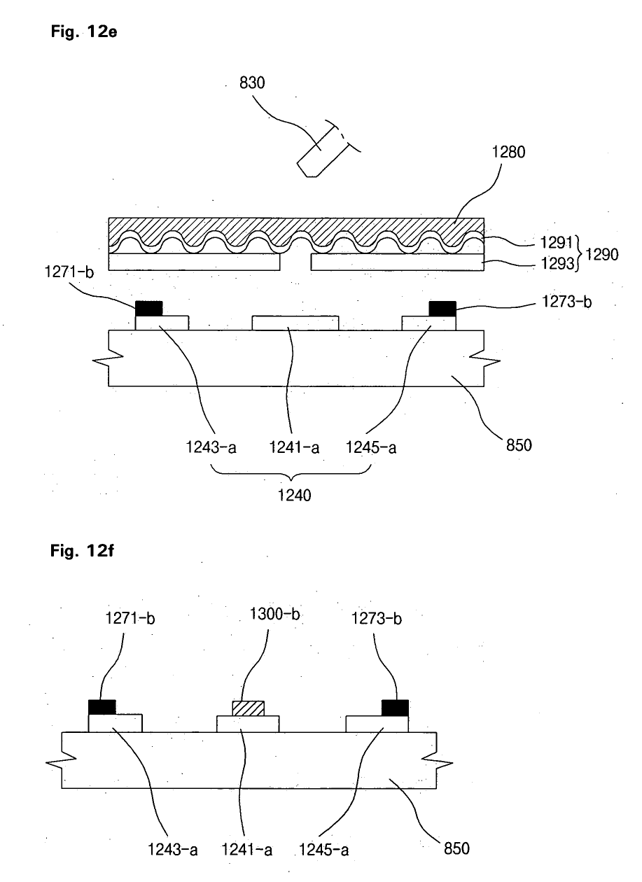

FIGS. 12a to 12f are views illustrating a method of manufacturing a plasma display panel according to a third embodiment of the present invention.

As shown in FIG. 12a, a transparent electrode paste 810 for forming a transparent electrode is coated on a screen mask 1220. The transparent electrode paste 810 is pushed out downwardly using a squeeze 830. The screen mask 1220 comprises a mesh net 1221 and a pattern forming layer 1223. In the pattern forming layer 1223, the width of a transparent electrode pattern serving as a sustain electrode is the same as the width of a transparent electrode pattern serving as a scan electrode.

As shown in FIG. 12b, transparent electrodes 1240 are formed on a glass substrate 850. The width of each of the transparent electrodes 1040 is the same. One transparent electrode 1241-a of the transparent electrodes 1040 serves as a sustain electrode, and each of two transparent electrodes 1243-a, 1245-a adjacent to the transparent electrode 1241-a serves as a scan electrode.

As shown in FIG. 12c, to form bus electrodes on the transparent electrodes 1243-a, 1245-a serving as the scan electrode, a copper paste 1250 is coated on the screen mask 1220 and is then pushed out using the squeeze 830.

As shown in FIG. 12d, bus electrodes 1271-b, 1273-b formed of copper are formed on the transparent electrodes 1243-a, 1245-a serving as the scan electrode.

As shown in FIG. 12e, to form bus electrodes on the transparent electrode 1241-a serving as the sustain electrode, an Ag paste 1280 is coated on the screen mask 1290 and is then pushed out using the squeeze 830.

As shown in FIG. 12f, a bus electrode 1300-b formed of silver is formed on the transparent electrode 1241-a serving as the sustain electrode.

In the electrode structure of the plasma display panel according to the third embodiment of the present invention, the bus electrodes of the sustain electrode are formed of silver and the bus electrodes of the scan electrode are formed of copper. Since the resistivity of silver is lower than the resistivity of copper, the resistance of the sustain electrode is lower than the resistance of the scan electrode. Therefore, the third embodiment of the present invention can reduce brightness deviation.

FIG. 13 is a view illustrating a current flowing through the electrodes of the plasma display panel according to the first to third embodiments of the present invention. A current at the end point of the second sustain electrode Z₂ in FIGS. 7, 9 and 11 is twice of a current at the end point of the second scan electrode Y₂ or the third scan electrode Y₃.

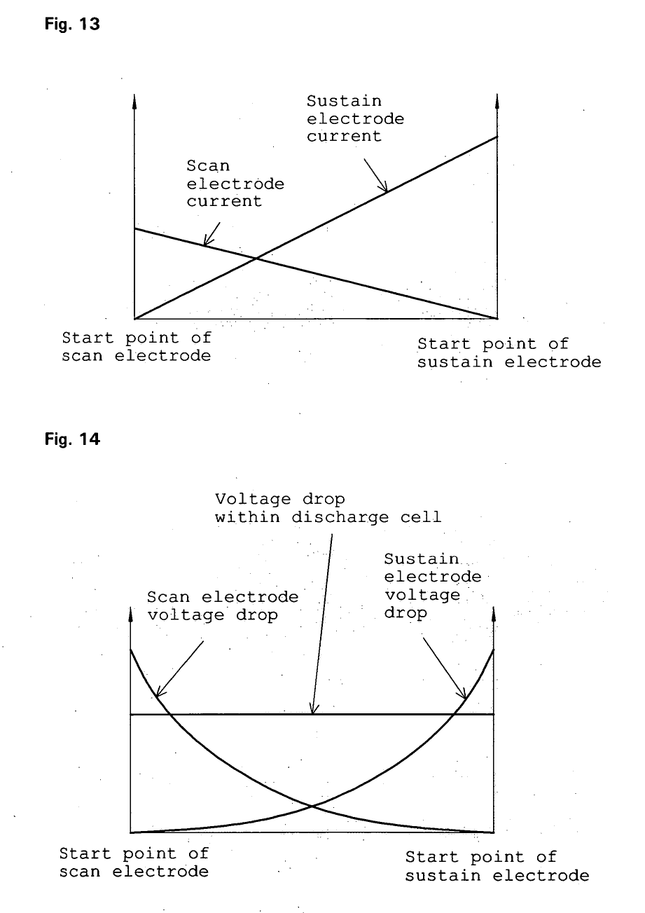

FIG. 14 shows a voltage drop by the electrodes of the plasma display panel according to the first to third embodiments of the present invention. If the width of the sustain electrode is wider than the width of the scan electrode as in the first embodiment of FIG. 7, the thickness of the sustain electrode is greater than the thickness of the scan electrode as in the second embodiment or the resistivity of the sustain electrode is lower than the resistivity of the scan electrode as in the third embodiment, the difference between a voltage drop in the sustain electrode and a voltage drop in the scan electrode is smaller than the difference between a voltage drop in the sustain electrode and a voltage drop in the scan electrode in the related art. Therefore, brightness deviation can be reduced.

The embodiment of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display panel comprising:
a first electrode having a first cross section area;
a second electrode having a second cross section area larger than the first cross section area, and forming a sustain electrode pair along with the first electrode; and
a third electrode having a third cross section area smaller than the second cross section area, and forming another sustain electrode pair along with the second electrode.

2. The plasma display panel as claimed in claim 1, wherein the first electrode and the third electrode serve as a scan electrode, and the second electrode serves as a sustain electrode.

3. The plasma display panel as claimed in claim 1, wherein the width of the second electrode is wider than the width of each of the first electrode and the third electrode.

4. The plasma display panel as claimed in claim 1, wherein the thickness of the second electrode is greater than the thickness of each of the first electrode and the third-electrode.

5. The plasma display panel as claimed in claim 1, wherein each of the first electrode, the second electrode and the third electrode comprises a transparent electrode, and
the width of the transparent electrode of the second electrode is wider than the width of each of the transparent electrode of the first electrode and the transparent electrode of the third electrode.

6. The plasma display panel as claimed in claim 1, wherein each of the first electrode, the second electrode and the third electrode comprises a bus electrode, and
the width of the bus electrode of the second electrode is wider than the width of each of the bus electrode of the first electrode and the bus electrode of the third electrode.

7. The plasma display panel as claimed in claim 1, wherein each of the first electrode, the second electrode and the third electrode comprises a transparent electrode, and
the thickness of the transparent electrode of the second electrode is greater than the thickness of each of the transparent electrode of the first electrode and the transparent electrode of the third electrode.

8. The plasma display panel as claimed in claim 1, wherein each of the first electrode, the second electrode and the third electrode comprises a bus electrode, and
the thickness of the bus electrode of the second electrode is greater than the thickness of each of the bus electrodes of the first electrode and the bus electrodes of the third electrode.

9. The plasma display panel as claimed in claim 3, wherein the width of the second electrode is 1.6 to 2.0 times of the width of the first electrode or the third electrode.

10. The plasma display panel as claimed in claim 4, wherein the thickness of the second electrode is 1.6 to 2.0 times of the width of the first electrode or the third electrode.

11. A plasma display panel comprising:
a first electrode having a first resistivity;
a second electrode having a second resistivity lower than the first resistivity, and forming a sustain electrode pair along with the first electrode; and
a third electrode having a third resistivity higher than the second resistivity, and forming another sustain electrode pair along with the second electrode.

12. The plasma display panel as claimed in claim 11, wherein the first electrode and the third electrode serve as a scan electrode, and the second electrode serves as a sustain electrode.

13. The plasma display panel as claimed in claim 11, wherein the width of the second electrode is wider than the width of each of the first electrode and the third electrode.

14. The plasma display panel as claimed in claim 11, wherein the thickness of the second electrode is greater than the thickness of each of the first electrode and the third electrode.

15. The plasma display panel as claimed in claim 11, wherein the first electrode and the third electrode are formed of copper, and
the second electrode is formed of silver.

16. A plasma display panel comprising:
a first electrode having a first resistance;
a second electrode having a second resistance lower than the first resistance, and forming a sustain electrode pair along with the first electrode; and
a third electrode having a third resistance higher than the second resistance, and forming another sustain electrode pair along with the second electrode.

17. The plasma display panel as claimed in claim 16, wherein the cross section area of the second electrode is larger than the cross section area of each of the first electrode and the third electrode.

18. The plasma display panel as claimed in claim 16, wherein the width of the first electrode, the width of the second electrode and the width of the third electrode are the same, and
the thickness of the second electrode is greater than the thickness of each of the first electrode and the third electrode.

19. The plasma display panel as claimed in claim 16, wherein the thickness of the first electrode, the thickness of the second electrode and the thickness of the third electrode are the same, and
the width of the second electrode is wider than the width of each of the first electrode and the third electrode.

20. The plasma display panel as claimed in claim 16, wherein the cross section area of the first electrode, the cross section area of the second electrode and the cross section area of the third electrode are the same, and
the resistivity of the second electrode is lower than the resistivity of each of the first electrode and the third electrode.
